(19) United States
(12) Patent Application Publication
(10) Pub. No.: US 2002/0112061 A1
(43) Pub. Date: Aug. 15, 2002

(54) Web-site admissions control with denial-of-service trap for incomplete HTTP requests

(76) Inventors: Fu-Tai Shih, San Jose, CA (US); Sandya Bhoajaraj, Santa Clara, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 09/780,308

(22) Filed: Feb. 9, 2001

(51) Int. Cl. G06F 15/16

(52) U.S. Cl. 709/229; 709/218

(57) ABSTRACT

A web site includes a denial-of-service trap as part of its admission control module. The trap forwards client requests with incomplete headers to a request assembler, where they are queued. If a selected queue is full, the oldest request is bumped. A request remains in the queue until it is matched with an incoming packet (which would provide, extend, or possibly complete the header), or until a timeout occurs or until it is bumped. Complete requests are passed toward a request processor for normal processing. In the event of an HTTP-level denial-of-service attack, requests with deliberately incomplete headers do not encumber the request processor, so normal service can continue.

### BACKGROUND OF THE INVENTION

The present invention relates to computers and, more particularly, to computers configured as servers on the World Wide Web. A major objective of the present invention is to reduce vulnerability of web sites to HTTP-level denial-of-service attacks.

Over the past several years, the World Wide Web has grown as a major enabler for research, entertainment, social interaction and business. The World Wide Web comprises a large number of web sites, each with its own purpose, which is effected by responding to requests from remote client computers. The hardware underlying each site inherently has limits on the number of requests it can respond to at any one time. As that number is approached or when it is exceeded, a web site may lose the ability to respond promptly to client requests and even hang up or break down. Such failures typically impair the purpose of the site, e.g., desired traffic and/or profits may be lost.

While ideally a web site would have sufficient capacity to handle its peak load, it is in general not cost effective to maintain continuously sufficient capacity to handle infrequent surges in demand. In addition, the peak level may be underestimated. Thus, many web sites experience excessive traffic from time to time. To avoid severe disruption of service, admission control can be implemented whereby requests are prioritized (e.g. requests associated with continuing sessions are given priority over requests beginning sessions), with some lower priority requests being rejected or deferred. A particularly effective deferral scheme is disclosed in U.S. Pat. Nos. 6,006,269 and 6,055,564 to Phaal, in which clients are informed of a time that they can resubmit a request that has been deferred; a request so resubmitted is assigned a higher priority than comparable first submissions. Effective as Phaal's admission control system is, it is not designed to handle malicious denial-of-service attacks.

Malicious attacks on web sites take many forms. In some cases, information is stolen and/or altered; in others, the software running the site is destroyed. A “denial-of-service” attack involves flooding a site with requests so that legitimate requests are not serviced. Denial-of-service attacks can occur at the network (TCP or “Transmission Control Protocol”) level. For example, TCP requires three-way handshaking: 1) a client request for a synchronized connection, 2) an host acknowledgment of the client request plus a host request for a synchronized connection, and 3) a client acknowledgment of the host request. When the host sends its acknowledgement/request, it dedicates connection resources waiting for the client's acknowledgement. If the client fails to send the acknowledgement, the dedicated resource is not available for other tasks. Typically, the host will free the resource after some predetermined time-out interval.

However, if a malicious attacker sends many requests within the time-out interval, all available connection resources can be tied up at once. If the attacker continues to send requests, connection resources freed upon timeout can be immediately tied up again. The results may crash the host site; in any event, legitimate clients are denied prompt service and the site's purpose is frustrated.

Firewalls can be used to protect a site against many malicious attacks. Packet-filtering firewalls are routers that filter out some requests according to TCP header information, for example, packet source, destination, and type (FTP (File Transfer Protocol), TELNET, HTTP (Hypertext Transfer Protocol)). Such firewalls can be effective against network-level denial-of-service attacks. However, more sophisticated HTTP level denial-of-service attacks can get through packet-filtering firewalls.

In an HTTP-level denial-of-service attack, the TCP connection is completed and a connection made available to the HTTP application. The HTTP application then devotes a resource to that connection, waiting for a header to arrive. A denial-of-service attack can be effected by sending the connection requests and then withholding all or part of the header needed to complete the request.

However, a firewall may serve many web sites and the optimal filtering criteria may be different for different sites. In principle, a firewall could tailor filtering according to packet destination. As a practical matter, however, administrators of web servers may not have access to the router so as to be able to configure the firewall. Also, because a firewall can service many web servers, it may be cumbersome for it to preserve sufficient information for a site-by-site diagnosis of failures. Accordingly, a more flexible and convenient method of preventing site failures due to HTTP-level denial-of-service attacks and other extraordinary events is desired.

### SUMMARY OF THE INVENTION

The present invention provides an admission control system with a denial-of-service trap for an HTTP server. The admissions control system includes a filter for incomplete HTTP requests (e.g., connections without headers and connections with incomplete headers). The filter allows complete HTTP requests to pass toward an HTTP request processor; incomplete requests are forwarded to a request assembler. “Toward” here, means either directly to the request processor or to an intermediate function, e.g., a deferral manager and/or a decryption engine, for subsequent transmission to the request processor.

The request assembler stores each received incomplete HTTP request in a queue. When the queue is full, a previously stored incomplete HTTP request can be retired to make room for a new one. A retired incomplete HTTP request is not passed on to the request processor, but is merely dropped from the system. In addition, an incomplete request can be retired upon a time out; a message notifying the client that made the request and/or a management system can be generated. Herein, a request “expires” when it is retired due to a time out, and a request is “bumped” when it is retired to make room for a new request when a queue is full.

In one embodiment, separate queues are provided for requests without headers and requests with incomplete headers. Separate notifications are provided indicating when the incomplete-header queue is full and when the no-header queue is full. This can help diagnostics, e.g., in the determination of the nature of a denial-of-service attack.

A method of the invention involves withholding incomplete requests from a request processor and storing them, retiring a previously stored incomplete request as necessary when the storage is full. In addition, a timeout can be used to determine when to retire requests. Optionally, a notification can be generated to the client that is the source of the dumped message; alternatively or in addition, a record can be made as an alert to the site administrator and/or for diagnostic purposes. The incomplete requests can be stored in a queue, with the oldest retired first when additional locations are required. If there are plural queues, an additional step of selecting a queue can be employed. For example, a first queue can be selected for storing requests without headers, while a second queue can be selected for storing requests that have incomplete headers.

A major advantage of the present invention is the reduction in vulnerability to denial-of-service attacks. Due to the location at the web server, incomplete requests can be stored pending completion without tying up router resources. A firewall, to the contrary, would tend to be more resource constrained in storing and assembling requests. Another advantage of the present invention is that the request trap can be cost-effectively implemented in the context of other admissions control functions, such as deferral management, which are based on the same header information. These and other features and advantages of the invention are apparent from the description below with reference to the following drawings.

### BRIEF DESCRIPTION OF THE DRAWINGS

FIG. 1 is a schematic block diagram of a host site with a denial-of-service trap in accordance with the present invention.

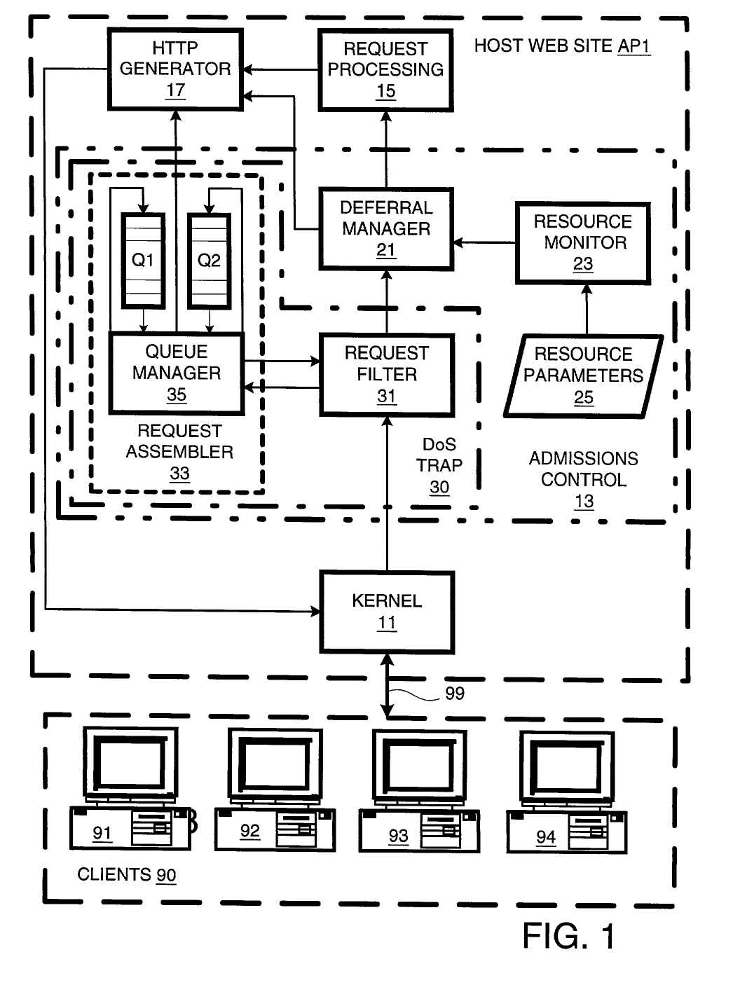

FIG. 2 is a flow chart of a denial-of-service counter method of the invention practiced in the context of the host site of FIG. 1.

### DESCRIPTION OF THE PREFERRED EMBODIMENTS

In accordance with the present invention, a host site AP1 comprises an operating system kernel 11, an admissions control module 13, a request processor 15, and a web-page (HTTP) generator 17. Host site AP1 can be accessed by a large number of client computers 90, e.g., client computers 91, 92, 93, and 94, via the Internet, indicated by connection 99. Admissions control module 13 includes a deferral manager 21, and a resource monitor 23 for monitoring utilization resource parameters 25, a denial-of-service (DoS) trap 30. DoS trap 30 includes a request filter 31 and a request assembler 33. Request assembler 33 includes a “no-header” queue Q1, an “incomplete-header” queue Q2, and a queue manager 35. Request processor can handle 1024 connections; each queue Q1, Q2 can handle half that many requests, in this case, each queue is 512 requests deep.

During normal operation, a client computer, e.g., computer 91, sends a request to host site AP1 via the Internet 99. The request is received at kernel 11. Assuming the request is complete, it is passed by DoS trap 30 to deferral manager 21, which normally passes the request to request processor 15. Request processor 15 generates an appropriate response to the request. HTTP generator 17 conforms the response to the HTTP protocol, which is then transmitted to kernel 11 for communication to client computer 91. As appropriate, HTTP generator 17 can also encrypt messages.

During a traffic peak, deferral manager 21 may defer some requests. Resource monitor 23 monitors resource parameter 25, e.g., CPU utilization, on an ongoing basis. When utilization reaches a level where it is difficult to respond to all requests reasonably quickly, deferral manager 21 implements a predetermined admissions policy. For example, requests associated with on-going sessions can be given priority over requests initiating new sessions. Also, some clients may be given priority over others.

Rather than rejecting low priority requests outright, deferral manager 21 can send a deferral message indicating to the deferred client when its request should be reasserted. HTTP generator 17 can, for example, associate a unique URL with a link as it conforms the deferral message to the HTTP protocol. If the requestor activates the link after the appropriate interval, deferral manager 21 recognizes this is a reassertion of a deferred request and assigns a high priority to the request so that it is passed to request processor 15. In addition to DoS trapping and deferral management, admission control module 13 can perform other functions, such as decryption.

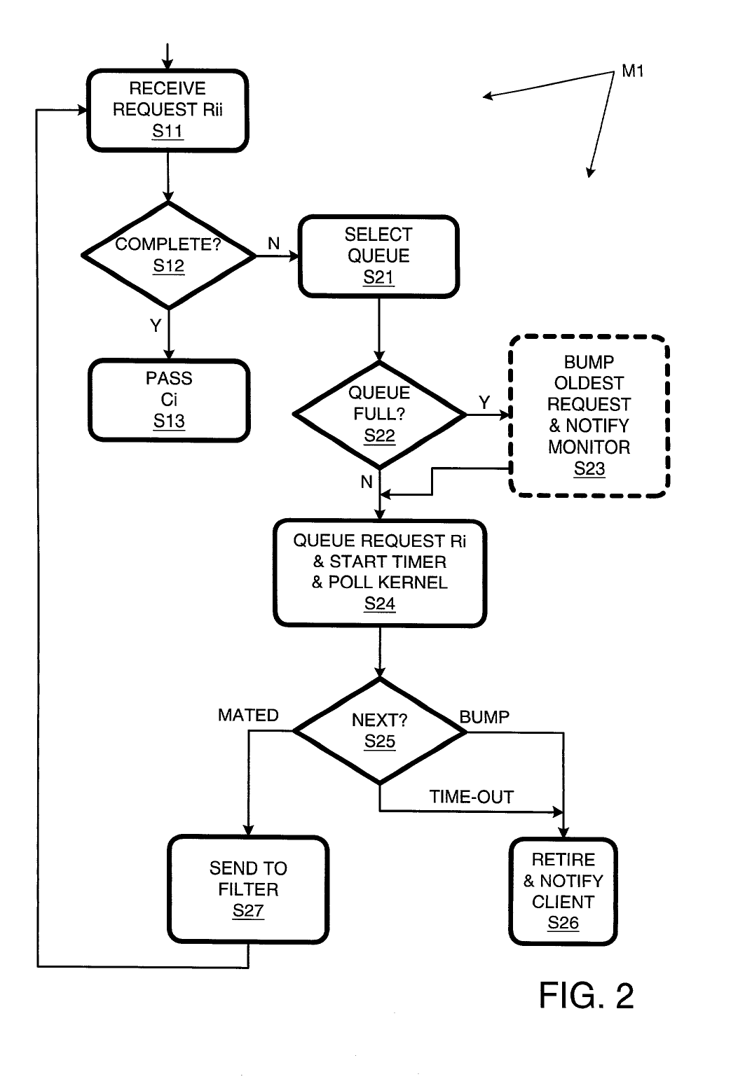

Incomplete requests are handled by DoS trap 30, which implements a method M1, which is flow-charted in FIG. 2. A request is received a step S11 by request filter 31. Filter 31 examines the request for completeness at step S12. If it is complete, it is passed toward request processor 15; specifically, the complete request is passed to deferral manager 21, which acts on the request as described above at step S13.

If, at step S12, the request is determined to be incomplete, it is forwarded to request assembler 33. At step S21, request assembler 33 selects a queue for storing the incomplete request. Specifically, a request with no header is stored in queue Q1, while a request with an incomplete header is stored in queue Q2.

Once the queue is selected, queue manager 35 determines whether or not the selected queue is full. If it is, a previously stored request is bumped at step S23. In the illustrated embodiment, the request that has been stored the longest time is bumped. However, in alternative embodiments, other factors can be considered in determining which previously stored request to “bump”. Whether or not a previously stored request is bumped, the present request is stored in the selected queue at step S24. Concomitantly, a timer in queue manager 35 is started, and request assembler 33 polls kernel 11 for packets associated with the request.

A request remains in the queue until, at step S25, one of three things happens: mating, bumping or timeout. If no associated packet is received by kernel 11 in time, a request will either time out or be bumped. In either case, the request is retired, in other words, not stored anymore. Optionally, a retirement notice can be sent to the client that sent the request. For example, the notice can be “the requested site is not responding due to high Internet traffic, please try again later”.

If, before a request is retired, kernel 11 responds to the polling initiated at step S24 with a packet that provides all or part of the header for the request, request assembler 33 mates the original request with the new packet at step and forwards the augmented request to request filter 31 at step 26. This returns method M1 to step S11.

In this iteration of step S11, the request is either complete or has an incomplete header. Presumably, the request does not completely lack a header. If the request is complete, as determined at step S12, it is passed toward request processor 15 at step S13. If it is incomplete, queue Q2 is selected. Depending on the original status of the request, this may be the same as the prior queue for this request or different. In any event, if queue Q2 is full, the oldest previously stored request is bumped at step S23. Also, a timer is started anew for the request and polling of kernel 11 for associated packets is resumed. The exit options are the same as in the first iteration: mating, time-out, and bumping.

The present invention provides for many alternatives to the embodiments described above. A DoS trap can be built into a request processor or into an operating system kernel. It can run on the same or different hardware than the request processor. However, including a DoS trap in an admissions control module brings a certain efficiency, since similar information is used for DoS traps and deferral managers. Where the DoS trap is included in the request processor, upgrading the DoS trap for new types of attacks would require upgrading the request processor—which can vary from server to server. Including the DoS trap at the server instead of the router, e.g., as part of a firewall, makes it easier to customize on a server-by-server basis. For example, servers may require different time out periods and queue depths for optimal effectiveness.

The present invention has applicability in the fields of computer networking, e-commerce, and Internet appliances. Depending on the particular context, the filtering can be more or less severe. Also, a choice is available whether to notify clients of retired requests. The DoS trap can be programmed with a knowledge base to help distinguish likely from unlikely sources of DoS attacks. These and other variations upon and modifications to the described embodiments are provided for by the present invention, the scope of which is defined by the following claims.

What is claimed is:

1. An admissions control system for a host site comprising a trap that withholds from a request processor incomplete HTTP requests and that retires incomplete HTTP requests to avoid exceeding a storage limitation.

2. A system as recited in claim 1 further comprising a deferral manager, said trap sending complete HTTP requests to said deferral manager, said deferral manager sending some of said complete HTTP requests to said request processor and responding with deferral messages to some others of said complete HTTP requests.

3. A system as recited in claim 1 wherein said trap includes at least one queue and a queue manager, said queue manager storing incomplete HTTP requests in said queue, said queue manager retiring a previously stored recent incomplete HTTP request when necessary to make room for a new incomplete HTTP request.

4. A system as recited in claim 3 wherein said trap includes first and second queues, said queue manager storing requests without headers in said first queue and requests with incomplete headers in said second queue.

5. A method of admissions control for a host site, said method comprising
withholding incomplete HTTP requests from a request processor until they are complete; and
retiring incomplete HTTP requests when associated storage limits are reached.

6. A method as recited in claim 5 further comprising:
passing complete HTTP requests to a deferral manager;
admitting some of said HTTP requests to a request processor; and
sending a deferral response to some others of said complete HTTP requests.

7. A method as recited in claim 5 further comprising:
storing a first incomplete HTTP request in a queue; and
retiring a previously stored incomplete HTTP request in said queue when necessary to make room for said first incomplete HTTP request.

8. A method as recited in claim 7 wherein, in said storing step, HTTP requests without headers are stored in a first queue and HTTP requests with incomplete headers are store in a second queue.
